(19) United States
(12) Patent Application Publication
(10) Pub. No.: US 2010/0203851 A1
(43) Pub. Date: Aug. 12, 2010

(54) WIRELESS TRANSMISSION DEVICE AND WIRELESS TRANSMISSION METHOD

(75) Inventors: Hiroaki Ishihara, Fuchu-shi (JP); Masahiro Hosoya, Kawasaki-shi (JP); Kohei Onizuka, Nerima-ku (JP); Shoji Otaka, Yokohama-shi (JP); Osamu Watanabe, Chigasaki-shi (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/553,180

(22) Filed: Sep. 3, 2009

(30) Foreign Application Priority Data
Feb. 12, 2009 (JP) 2009-029630

(51) Int. Cl. H04B 1/02

(52) U.S. Cl. 455/102

(57) ABSTRACT

A wireless transmission device includes an adding/subtracting unit configured to subtract a second signal and a third signal from a first signal to generate the second signal; a modulating unit configured to modulate the second signal to generate a fourth signal; a demodulating unit configured to demodulate the fourth signal to generate the third signal; and a transmitting unit configured to transmit the fourth signal.

### CROSS-REFERENCE TO THE INVENTION

This application is based upon and claims the benefit of priority from the prior Japanese Patent Application No. 2009-029630, filed on Feb. 12, 2009; the entire contents of which are incorporated herein by reference.

### BACKGROUND OF THE INVENTION

1. Field of the Invention

The present invention relates to a wireless transmission device having feedback loops and a wireless transmission method.

2. Description of the Related Art

In a conventional wireless transmission device, there is a Cartesian loop using a feedback loop including, for example, a transmission signal generating unit and a reception signal generating unit. Disclosed is a technique in which a loop filter is disposed in the Cartesian loop in order to ensure a stable transmission operation (see U.S. Pat. No. 4,933,986).

### BRIEF SUMMARY OF THE INVENTION

In the above-described prior art, when a time delay of a constant group delay occurs in an RF (radio frequency) signal path of the feedback loop, an output signal from the reception signal generating unit that is a feedback signal suffers a phase delay in relation to the frequency and the delay time. As a result, the phase margin deteriorates corresponding to the phase delay to cause oscillation, thereby making it difficult to ensure the stability of the transmission operation. Especially when the band of the RF signal is widened and thereby the unity gain frequency is increased, the phase delay is increasingly affected by the time delay to increase the deterioration amount of the phase margin. Therefore, it has been difficult to widen the band of the wireless transmission device. In consideration of the above, an object of the present invention is to provide a wireless transmission device and a wireless transmission method capable of ensuring the stability of the transmission operation.

A wireless transmission device according to an aspect of the present invention includes: an adding/subtracting unit configured to subtract a second signal and a third signal from a first signal to generate the second signal; a modulating unit configured to modulate the second signal generated by the adding/subtracting unit to generate a fourth signal; a demodulating unit configured to demodulate the fourth signal to generate the third signal; and a transmitting unit configured to transmit the fourth signal.

A wireless transmission method according to an aspect of the present invention includes: an adding/subtracting unit subtracting a second signal and a third signal from a first signal to generate the second signal; a modulating unit modulating the second signal generated by the adding/subtracting unit to generate a fourth signal; a demodulating unit demodulating the fourth signal to generate the third signal; and a transmitting unit transmitting the fourth signal.

### BRIEF DESCRIPTION OF THE DRAWINGS

FIG. 1 is block diagram showing a wireless transmission device according to a first embodiment of the present invention.

FIG. 2 is a flowchart showing an example of a procedure of the operation of the wireless transmission device.

FIG. 3 is a graph showing amplitude characteristics and phase characteristics of signals F2, F3 and F6 shown in FIG. 1.

FIG. 4 is a block diagram showing a wireless transmission device according to a modification example 1 of the first embodiment.

FIG. 5 is a block diagram showing a wireless transmission device according to a modification example 2 of the first embodiment.

FIG. 6 is a block diagram showing a wireless transmission device according to a second embodiment.

FIG. 7 is a graph showing amplitude characteristics and phase characteristics of signals F2, F3 and F6 when a filter 19 shown in FIG. 6 has high-pass frequency characteristics.

FIG. 8 is a graph showing amplitude characteristics and phase characteristics of signals F2, F3 and F6 when the filter 19 shown in FIG. 6 has band-pass frequency characteristics.

FIG. 9 is a block diagram showing a wireless transmission device according to a third embodiment.

FIG. 10 is a block diagram showing a wireless transmission device according to a fourth embodiment.

FIG. 11 is a block diagram showing a wireless transmission device according to a fifth embodiment.

FIG. 12 is a block diagram showing a wireless transmission device according to a sixth embodiment.

FIG. 13 is a block diagram showing a wireless transmission device according to a seventh embodiment.

FIG. 14 is a block diagram showing a wireless transmission device according to an eighth embodiment.

FIG. 15 is a block diagram showing a wireless transmission device according to a modification example 1 of the eighth embodiment.

FIG. 16 is a block diagram showing a wireless transmission device according to a modification example 2 of the eighth embodiment.

### DETAILED DESCRIPTION OF THE INVENTION

Hereinafter, embodiments of the present invention will be described with reference to the drawings.

### First Embodiment

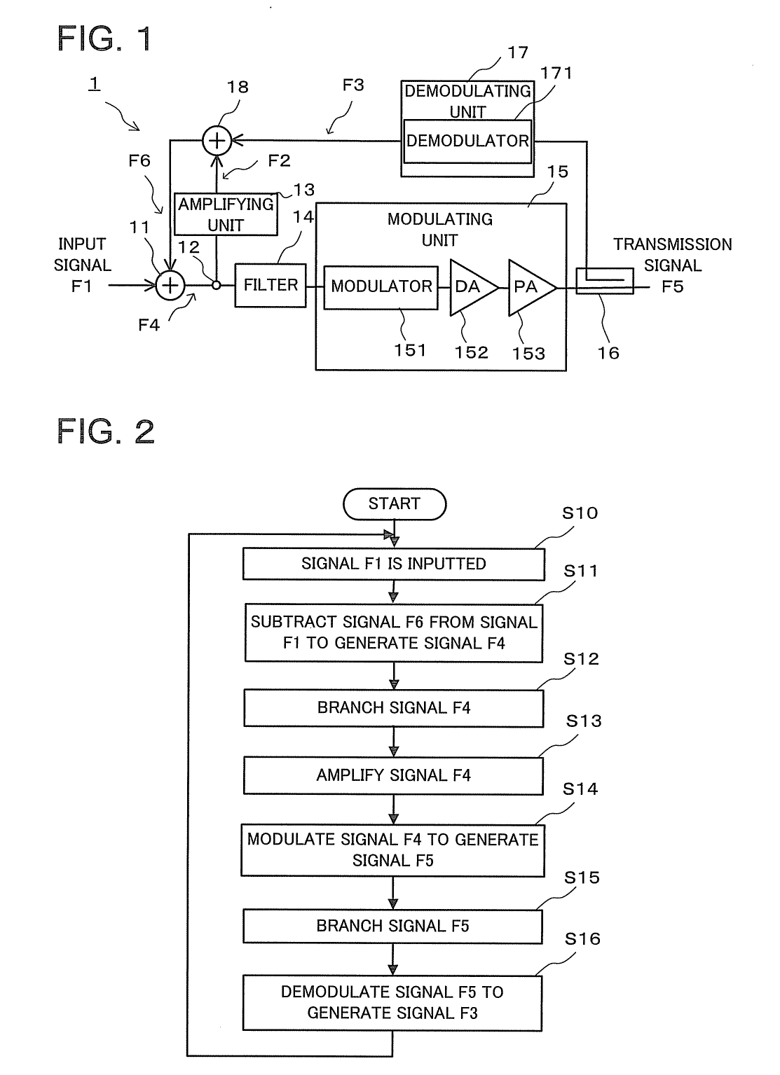

FIG. 1 is block diagram showing a wireless transmission device 1 according to a first embodiment of the present invention. The wireless transmission device 1 generates a transmission signal (transmission RF signal) and emits the signal from a not-shown antenna.

As shown in FIG. 1, the wireless transmission device 1 includes a subtractor 11, a branching device 12, an amplifying unit 13, a filter 14, a modulating unit 15, a coupler 16, a demodulating unit 17, and an adder 18. Note that an input signal F1 is a signal (first signal) for generating a transmission signal. A signal F2 is a signal (second signal) fed back from the branching device 12. A signal F3 is a signal (third signal) fed back from the demodulating unit 17. A signal F4 is a composite signal (second signal) generated by the subtractor 11. A signal F5 is a signal (fourth signal) generated by the modulating unit 15. A signal F6 is a composite signal (fifth signal) fed back from the adder 18.

The adder 18 adds the signal F2 from the amplifying unit 13 and the signal F3 generated by the demodulating unit 17 to generate the signal F6. The subtractor 11 subtracts the signal F6 generated by the adder 18 from the inputted signal F1 to generate the signal F4. The adder 18 and the subtractor 11 function as an adding/subtracting unit subtracting the second signal and the third signal from the first signal to generate the second signal. The adder 18 functions as an adder adding the second signal and the third signal to generate the fifth signal. The subtractor 11 functions as a subtractor subtracting the fifth signal generated by the adder from the first signal to generate the second signal.

The branching device 12 is connected to a signal path between the subtractor 11 and the filter 14. The branching device 12 branches the signal F4 generated by subtraction by the subtractor 11. The frequency (unity gain frequency) when the total gain (loop gain) of the gain of the branching device 12 and the gain of the amplifying unit 13 is 0 [dB] is set to a frequency higher than the frequency (unity gain frequency) when the total gain (loop gain) of the gain of the branching device 12, the gain of the modulating unit 15, the gain of the coupler 16, and the gain of the demodulating unit 17 (including also the gain of the filter 14 in this embodiment) is 0 [dB].

One of the signals F4 branched by the branching device 12 is inputted into the amplifying unit 13. The other of the signals F4 branched by the branching device 12 is inputted into the filter 14. In this embodiment, the signal F4 is branched by the branching device 12. However, if the subtractor 11 has two output ports, the branching device 12 can be omitted, as a result of which the number of parts can be reduced.

The amplifying unit 13 is connected to the signal path between the branching device 12 and the adder 18. The amplifying unit 13 amplifies the signal F4 branched by the branching device 12 and outputs the resulting signal as the signal F2. The signal F2 outputted from the amplifying unit 13 is inputted into the adder 18.

The signal path including the branching device 12 and the amplifying unit 13 constitute a first feedback loop generating the signal F2. Further, the signal path including the branching device 12, the filter 14, the modulating unit 15, the coupler 16, and the demodulating unit 17 constitutes a second feedback loop generating the signal F3. In this embodiment, to set the loop gain of the first feedback loop to 0 [dB] or greater, the amplifying unit 13 is disposed. However, if the loop gain of the first feedback loop is set to 0 [dB], the amplifying unit 13 can be omitted. In this case, the signal level of the signal F2 is equal to the signal level of the signal F4.

The filter 14 is a loop filter connected to the signal path between the branching device 12 and the modulating unit 15. The filter 14 is a low-pass filter to pass the signal F4 according to preset pass frequency characteristics, for example, low-pass frequency characteristics. The signal F4 passed through the filter 14 is inputted into the modulating unit 15.

The modulating unit 15 applies frequency modulation on the signal F4 to generate a harmonic signal (transmission signal) F5. The signal F5 generated by the modulating unit 15 is inputted into the coupler 16. The modulating unit 15 performs modulation of the signal F4 and amplification for the signal F5 using a common modulator 151, driver amplifier 152, power amplifier 153 and so on. The distortion of the signal generated by the modulating unit 15 including the power amplifier is suppressed by the first feedback loop. As a result, a large amount of distortion improvement is achieved in this embodiment. The modulator 151 functions as a modulating unit modulating the fourth signal generated by the adding/subtracting unit to generate the fifth signal. The driver amplifier 152 and the power amplifier 153 function as an amplifying unit amplifying the signal F4. To obtain the output power required for transmitting the signal F5, the power amplifier 153 or the driver amplifier 152 and the power amplifier 153 may be disposed on the output side (the side of the not-shown antenna) of the coupler 16.

The coupler 16 branches the signal F5 generated by the modulating unit 15. One of the signals F5 branched by the coupler 16 is inputted into the demodulating unit 17. The other of the signals F5 branched by the coupler 16 is transmitted by wireless via the not-shown antenna. The coupler 16 and the antenna function as a transmitting unit transmitting the fourth signal.

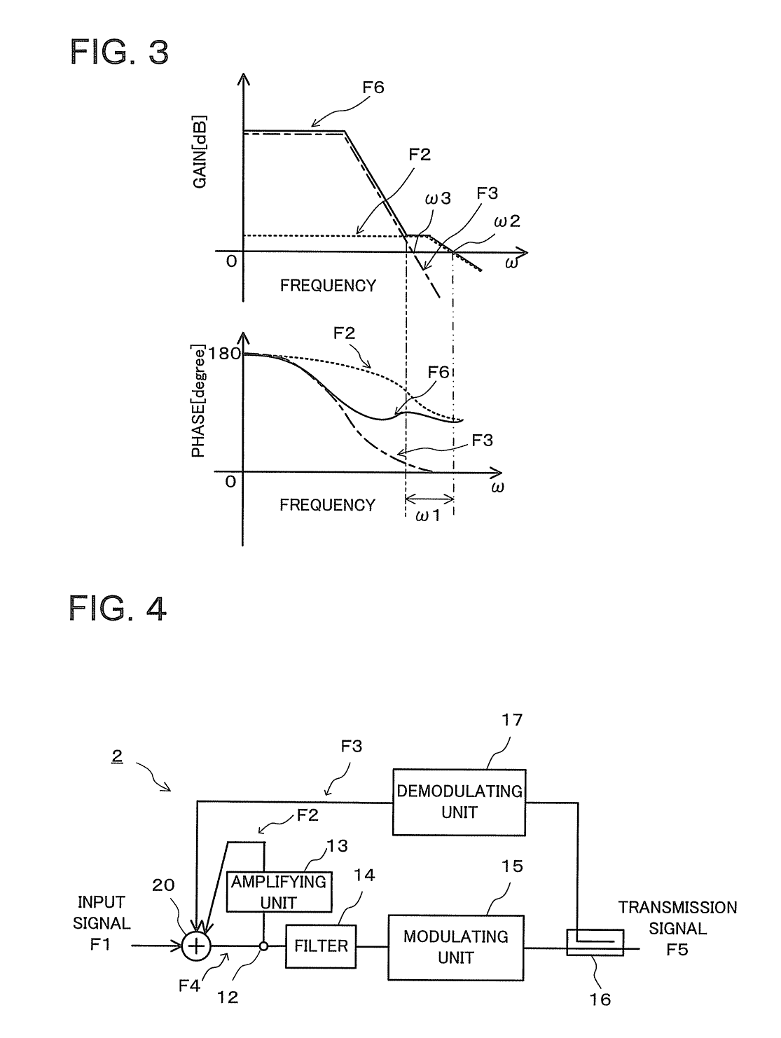

The demodulating unit 17 demodulates the signal F5 to generate the signal F3. The signal F3 has frequency characteristics (amplitude characteristics and phase characteristics) that the frequency thereof is defined by the pass frequency characteristics of the filter 14 (see later-described FIG. 3), and is inputted into the adder 18. The demodulating unit 17 may be composed only of a demodulator 171. Further, the demodulating unit 17 may be structured including an attenuator in addition to the demodulator 171 when the signal level of the signal F5 to be inputted thereinto is high. As a result, the signal level of the signal F5 can be attenuated to an appropriate level. The demodulating unit 17 functions as a demodulating unit demodulating the fourth signal generated by the modulating unit to generate the third signal.

### (Operation of Wireless Transmission Device 1)

FIG. 2 is a flowchart showing an example of a procedure of the operation of the wireless transmission device 1.

In the wireless transmission device 1, when the signal F1 is inputted (Step S10), the signal F6 from the adder 18 (the signal generated by adding the signal F2 from the amplifying unit 13 and the signal F3 from the demodulating unit 17) is subtracted from the signal F1 by the subtractor 11 (Step S11). Then, the generated signal F4 is branched by the branching device 12 (Step S12). Further, one of the branched signals F4 is amplified by the amplifying unit 13 and the resulting signal is outputted as the signal F2. (Step S13).

Then, the modulating unit 15 applies frequency modulation on the other of the signals F4 which has passed through the filter 14 to generate the signal F5 (Step S14). Then, the generated signal F5 is branches by the coupler 16 (Step S15). Further, the demodulating unit 17 demodulates the branched signal F5 to generate the signal F3 (Step S16).

FIG. 3 is a graph showing amplitude characteristics and phase characteristics in an open loop of the signals F2, F3 and F6 shown in FIG. 1.

The signal F3 generated by the demodulating unit 17 based on the signal passed through the second feedback loop is fed back to the adder 18. If a time delay of a constant group delay occurs in the second feedback loop, the signal F3 is affected by the time delay to cause a phase delay in proportion to the frequency and the delay time. The amplitude characteristics and the phase characteristics of the signal F3 at this time are expressed by one-dotted chain lines in FIG. 3. Even when the filter 14 is not included in the second feedback loop, the amplitude characteristics and the phase characteristics are almost the same as those in FIG. 3 due to not-shown parasitic elements. The parasitic elements include a parasitic capacitance of a wiring part, a parasitic resistance of the wiring part, and a parasitic inductance of the wiring part in addition to an input capacitance in the circuit block in FIG. 1 (this also applies to the following embodiments).

The signal F2 is a signal passed through the first feedback loop but not through the second feedback loop. Therefore, the signal F2 is never affected by the time delay due to the second feedback loop. The amplitude characteristics and the phase characteristics of the signal F2 at this time are expressed by broken lines in FIG. 3.

A unity gain frequency ω2 which the first feedback loop has at this time is set to higher than a unity frequency ω3 which the second feedback loop has (this also applies to the following embodiments). As a result of this, in a range ω1 in which the frequency of the first feedback loop is higher than the unity gain frequency ω3 of the second feedback loop, the total of the gains of the branching device 12 and the amplifying unit 13 in the first feedback loop is greater than the total of the gains of the branching device 12, the filter 14, the modulating unit 15, the coupler 16, and the demodulating unit 17 in the second feedback loop. As a result, the amplitude characteristics and the phase characteristics of the signal F6 are affected by the signal F2 in the frequency range ω1 as shown in FIG. 3 to be characteristics similar to the amplitude characteristics and the phase characteristics of the signal F2. Thus, if a sufficient phase margin of the signal F2 is secured, a phase margin can be secured for the signal F6 generated by addition, irrespective of the phase of the signal F3. In this embodiment, the phase of the signal F2 is close to 90 degrees near the unity gain frequency ω2 as shown by the phase characteristics in FIG. 3 so that a sufficient phase margin of the signal F2 is secured.

As described above, in the wireless transmission device 1 according to this embodiment, a sufficient phase margin of the signal F2 is secured even if a time delay of a constant group delay occurs in the first feedback loop, so that the stability of the transmission operation can be ensured irrespective of the phase of the signal F3.

Further, a phase delay may occur outside the second feedback loop through which the signal F3 passes to deteriorate the phase margin of the signal F3. Also in this case, by securing a sufficient phase margin of the signal F2, a phase margin can be secured for the signal F6 generated by addition, irrespective of a portion where the phase delay occurs. In particular, even if the band of the transmission signal is widened and thereby the unity gain frequency is increased, the phase margin for the signal F6 can be secured by securing a sufficient phase margin of the signal F2. As a result, the band of the wireless transmission device can be widened. Further, even if the order of the loop filter is increased and thereby the phase margin of the second feedback loop is decreased, the phase margin for the signal F6 can be secured by securing a sufficient margin of the signal F2. As a result, the order of the loop filter can be increased.

### Modification Example 1

FIG. 4 is a block diagram showing a wireless transmission device 2 according to a modification example 1 of the first embodiment. Though a total of two units, one adder and one subtractor, are provided to perform addition and subtraction on a plurality of fed back signals in the first embodiment, the present invention is not limited to that configuration.

In the modification example 1 of the first embodiment, an adding/subtracting unit 20 having three input terminals is used, and the amplifying unit 13 and the demodulating unit 17 are connected to the adding/subtracting unit 20. The adding/subtracting unit 20 subtracts the addition value of the signal F2 and the signal F3 from the input signal F1 to generate the signal F4.

Also in this modification example 1, the signal F2 does not pass through the second feedback loop including the filter 14, the modulating unit 15, the coupler 16, and the demodulating unit 17 as in the first embodiment. Therefore, the signal F2 is never affected by the time delay due to the second feedback loop, so that its amplitude characteristics and phase characteristics are the same as those in FIG. 3.

As described above, in the wireless transmission device 2 according to the modification example 1, a sufficient phase margin of the signal F2 is secured as in the first embodiment so that the stability of the transmission operation can be ensured irrespective of the phase of the signal F3.

Further, in the wireless transmission device 2 according to the modification example 1, one adding/subtracting unit 20 performs addition and subtraction on the input signal F1, the signal F2, and the signal F3 to generate the signal F4. As a result, the adder and the subtractor can be implemented by one unit, thereby reducing the number of parts and the manufacturing cost.

### Modification Example 2

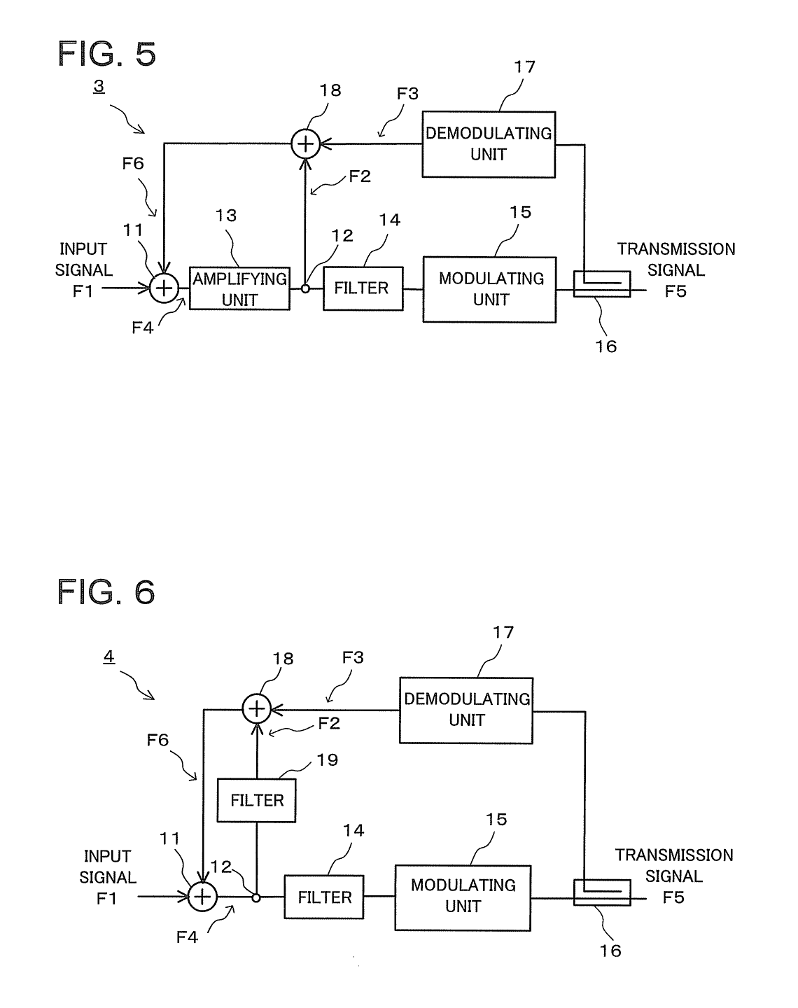

FIG. 5 is a block diagram showing a wireless transmission device 3 according to a modification example 2 of the first embodiment. Though the amplifying unit 13 is connected to the signal path between the branching device 12 and the adder 18 in the first embodiment, the present invention is not limited to that configuration.

In the wireless transmission device 3 according to the modification example 2 of the first embodiment, the amplifying unit 13 is connected to the signal path between the subtractor 11 and the branching device 12. The amplifying unit 13 amplified the signal F4 generated by the subtractor 11. The modulating unit 15 modulates the signal F4 passed through the filter 14 to generate the signal F5. The signal path including the amplifying unit 13 and the branching device 12 constitute the first feedback loop generating the signal F2. Further, the signal path including the amplifying unit 13, the branching device 12, the filter 14, the modulating unit 15, the coupler 16, and the demodulating unit 17 constitute the second feedback loop generating the signal F3.

Further, in this wireless transmission device 3, the unity gain frequency which the first feedback loop has is set to be higher than the unity gain frequency which the second feedback loop has. The signal F2 is never affected by the time delay due to the second feedback loop, so that its amplitude characteristics and phase characteristics are the same as those in FIG. 3.

As described above, also in the wireless transmission device 3 according to the modification example 2, a sufficient phase margin of the signal F2 is secured as in the first embodiment so that the stability of the transmission operation can be ensured irrespective of the phase of the signal F3.

### Second Embodiment

In the first embodiment, the unity gain frequency which the first feedback loop has is roughly defined by the gain of the amplifying unit 13. However, it is unclear how much this unity gain frequency is higher than the unity gain frequency which the second feedback loop has.

FIG. 6 is a block diagram showing a wireless transmission device 4 according to a second embodiment. The wireless transmission device 4 according to the second embodiment specifies the unity gain frequency which the first feedback loop has.

In the wireless transmission device 4, a filter 19 is connected to the signal path between the branching device 12 and the adder 18. The filter 19 functions as a filter unit passing the second signal according to preset pass frequency characteristics.

The modulating unit 15 modulates the signal F4 to generate the signal F5. The adder 18 and the subtractor 11 subtract the signal F2 passed through the filter 19 and the signal F3 generated by the demodulating unit 17 from the signal F1 to generate the signal F4.

The signal path including the branching device 12 and the filter 19 constitute the first feedback loop generating the signal F2. Further, the signal path including the branching device 12, the filter 14, the modulating unit 15, the coupler 16, and the demodulating unit 17 constitute the second feedback loop generating the signal F3.

The pass frequency characteristics of the filter 19 are set so that the unity gain frequency which the first feedback loop has is a unity gain frequency higher by a predetermined value than the unity gain frequency which the second feedback loop has. More specifically, the pass frequency characteristics of the filter 19 are set so that the frequency (unity gain frequency) when the total of the gains of the branching device 12 and the filter 19 is 0 [dB] has a value higher that that of the frequency (unity gain frequency) when the total of the gains of the branching device 12, the filter 14, the modulating unit 15, the coupler 16, and the demodulating unit 17 is 0 [dB]. The filter 19 has a gain of 0 [dB] or greater and has an amplifying function of the amplifying unit 13 shown in FIG. 1. The filter 19 may be one having any of low-pass frequency characteristics, high-pass frequency characteristics, and band-pass frequency characteristics. The cases of the respective pass frequency characteristics will be described below.

### (Case of Low-Pass Frequency Characteristics)

Since the above-described parasitic elements are not intentionally disposed elements, it is difficult to accurately estimate the element values. Further, since almost all of units are affected by the parasitic elements, the combined frequency characteristics of them are complicated. As a result, the phase margin of the first feedback loop may be 0 degree or less to fail to ensure the stability.

Hence, the filter 19 is made to have low-pass frequency characteristics, whereby the frequency characteristics of the signal F2 are determined by the low-pass filter 19 in the second embodiment. The amplitude characteristics and the phase characteristics of the signals F2, F3, and F6 in this case are the same as those in FIG. 3. In other words, in this embodiment, the low-pass frequency characteristics of the filter 19 are set so that the amplitude characteristics and the phase characteristics of the signal F2 are the same as those in FIG. 3 without being affected by the frequency characteristics determined by the parasitic elements.

As described above, the low-pass frequency characteristics of the filter 19 are set so that the amplitude characteristics and the phase characteristics of the signal F2 are the same as those in FIG. 3 in the wireless transmission device 4 according to the second embodiment. As a result, the unity gain frequency which the first feedback loop has can be specified irrespective of the parasitic elements. Further, the frequency band and the phase margin of the signal F2 can be arbitrarily set.

### (Case of High-Pass Frequency Characteristics)

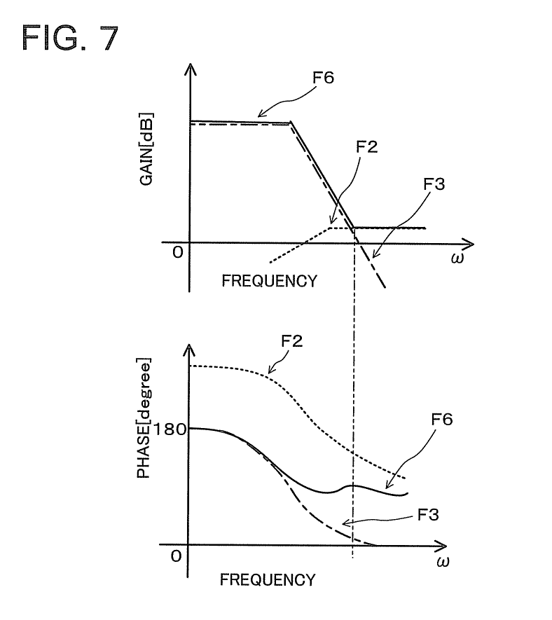

When the filter 19 is made to have high-pass frequency characteristics, the gain of the signal F2 is decreased by cutting the low frequency components, whereby the gain of the signal F2 passed through the filter 19 can be sufficiently decreased as composed to the signal F3 (see FIG.7). At this time, the effects of linearization of the modulating unit 15 by the signal F3 are almost the same as those in the case in which the first feedback loop generating the signal F 2 is not provided.

As described above, by making the filter 19 have the high-pass frequency characteristics, the gain of the signal F2 can be decreased in the wireless transmission device 4 according to the second embodiment. As a result, a decrease of the effects of linearization obtained by the signal F3 can be prevented, whereby the stability of the transmission operation can be ensured.

### (Case of Band-Pass Frequency Characteristics)

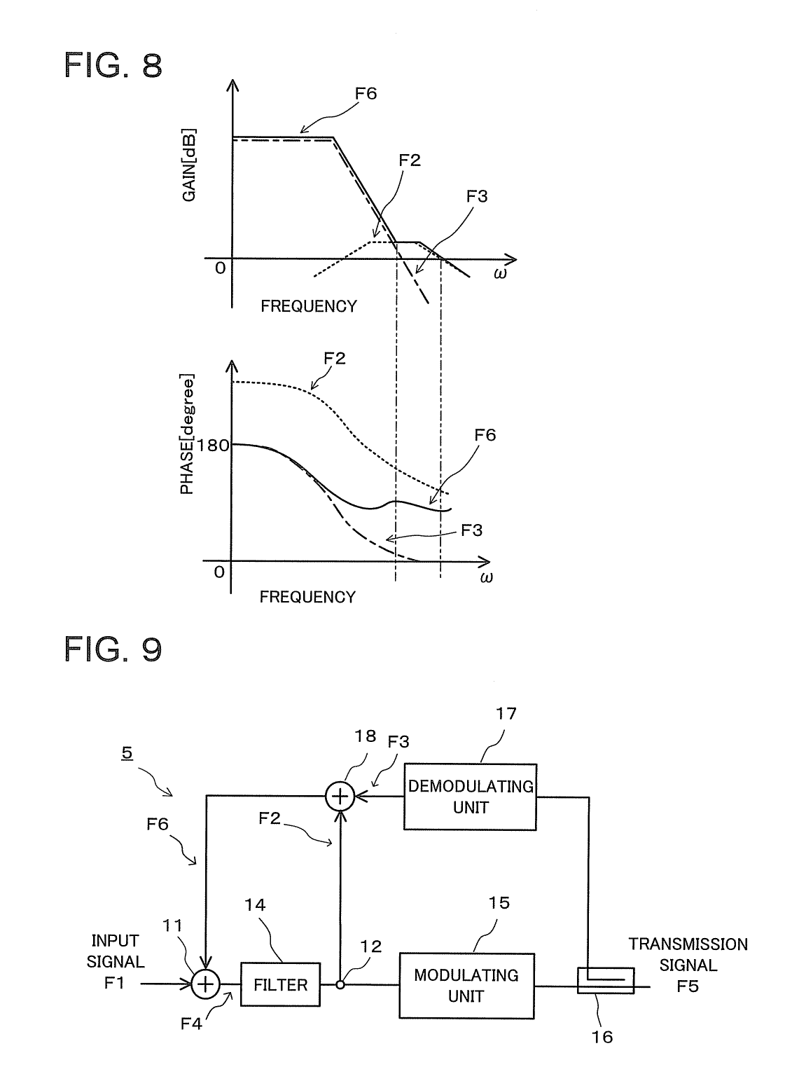

When the filter 19 is made to have band-pass frequency characteristics, the amplitude characteristics and the phase characteristics of the signals F2, F3, and F6 in the open loop are as those in FIG.8. The amplitude characteristics in FIG.8 correspond to the amplitude characteristics made by combining the case in which the filter 19 is made to have the low-pass frequency characteristics and the case in which the filter 19 is made to have the high-pass frequency characteristics.

As described above, in the wireless transmission device 4 according to the second embodiment, the filter 19 is made to have the band-pass frequency characteristics, whereby a sufficient phase margin of the signal F2 can be secured and a decrease of the effects of linearization obtained by the signal F3 can be prevented, so that the stability of the transmission operation can be further ensured.

### Third Embodiment

FIG. 9 is a block diagram showing a wireless transmission device 5 according to a third embodiment. In the third embodiment, the filter 14 is connected to the signal path between the subtractor 11 and the branching device 12. The filter 14 functions as a filter unit passing the second signal according to preset pass frequency characteristics. The filter 14 passes the signal F4 generated by the subtractor 11 according to low-pass frequency characteristics. In other words, in this third embodiment, the first feedback loop generating the signal F2 and the second feedback loop generating the signal F3 share the filter 14. The filter 14 has a gain of 0 [dB] or greater and has the amplifying function of the amplifying unit 13 shown in FIG. 1.

The modulating unit 15 modulates the signal F2 passed through the filter 14 to generate the signal F5. The adder 18 and the subtractor 11 subtract the signal F2 passed through the filter 14 and the signal F3 generated by the demodulating unit 17 from the signal F1 to generate the signal F4.

In this third embodiment, the signal path including the filter 14 and the branching device 12 constitute the first feedback loop generating the signal F2. The signal path including the filter 14, the branching device 12, the modulating unit 15, the coupler 16, and the demodulating unit 17 constitutes the second feedback loop generating the signal F3. Where the gain of the filter 19 is Af [dB], the gain of the modulating unit 15 is At [dB], the gain of the coupler 16 is Ac [dB], and the gain of the demodulating unit 17 is Ar [dB], the gain of the first feedback loop is Af [dB] and the gain of the second feedback loop is (Af+At+Ac+Ar) [dB]. The branching device 12 is shared between the first and second feedback loops, and therefore omitted here (this also applies to the fourth embodiment).

Hence, by setting (At+Ac+Ar) [dB] to a gain greater than 0 [dB], the gain of the second feedback loop can be made greater than the gain of the first feedback loop by (At+Ac+Ar) [dB]. As a result, the gains of the first and second feedback loops can be separately set, and the gain of the signal F2 can be set to be lower than the gain of the signal F3 as in FIG. 3.

As described above, in the wireless transmission device 5 according to the third embodiment, the filter 14 is shared between the first and second feedback loops. As a result, a filter can be disposed also in the first feedback loop without adding a new filter.

Further, in the wireless transmission device 5 according to the third embodiment, the total of the gain of the modulating unit 15, the gain of the coupler 16, and the gain of the demodulating unit 17 can be made greater than 0 [dB]. As a result, the gain of the signal F2 can be set to be lower than the gain of the signal F3, so that the distortion of the signal F6 can be suppressed to ensure the stability of the transmission operation.

### Fourth Embodiment

Though the gains of the first feedback loop and the second feedback loop can be arbitrarily set in the third embodiment, the difference between the frequency characteristics between the two feedback loops can be determined only by the frequency characteristics of the modulating unit 15, the coupler 16, and the demodulating unit 17.

A wireless transmission device 6 according to the fourth embodiment of the present invention is configured such that the difference between the frequency characteristics of the first feedback loop and the second feedback loop is arbitrarily settable.

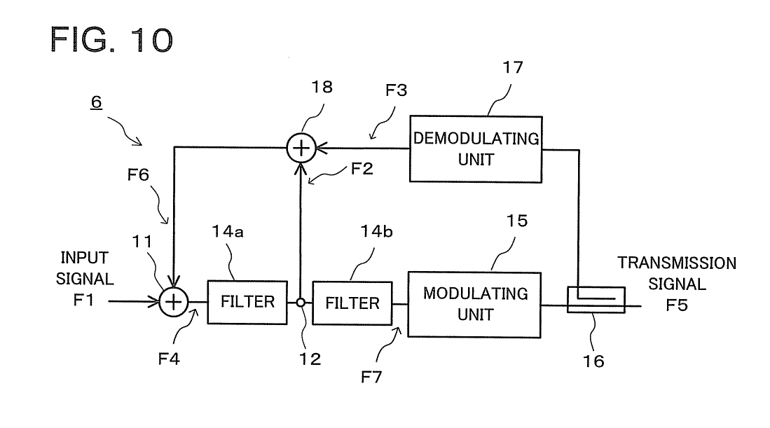

FIG. 10 is a block diagram showing the wireless transmission device 6 according to the fourth embodiment. In the fourth embodiment, two filters 14a and 14b are connected in series to the signal path between the subtractor 11 and the modulating unit 15. The filters 14a and 14b each have a gain of 0 [dB] or greater and have an amplifying function of the amplifying unit 13 shown in FIG. 1. The filter 14a passes the signal F4 generated by the subtractor 11 as the signal F2 having preset pass frequency characteristics. The filter 14a functions as a first filter unit passing the second signal generated by the adding/subtracting unit according to preset pass frequency characteristics. The filter 14b passes the signal F2 passed through the filter 14a as a signal F7 having preset pass frequency characteristics. The filter 14b functions as a second filter unit passing the second signal passed through the first filter unit according to preset pass frequency characteristics.

The branching device 12 splits the signal F2 passed through the filter 14a. The modulating unit 15 modulates the signal F7 passed through the filter 14b to generate the signal F5.

The signal path including the filter 14a and the branching device 12 constitute the first feedback loop generating the signal F2. The signal path including the filters 14a and 14b, the branching device 12, the modulating unit 15, the coupler 16, and the demodulating unit 17 constitute the second feedback loop generating the signal F3. Where the gain of the filter 14a is Afa [dB], the gain of the filter 14b is Afb [dB], the gain of the modulating unit 15 is At [dB], the gain of the coupler 16 is Ac [dB], and the gain of the demodulating unit 17 is Ar [dB], the gain of the first feedback loop is Afa [dB] and the gain of the second feedback loop is (Afa+Afb+At+Ac+Ar) [dB].

Hence, by setting (Afb+At+Ac+Ar) [dB] to be a gain greater than 0 [dB], the gain of the second feedback loop can be made greater than the gain of the first feedback loop by (Afb+At+Ac+Ar) [dB]. As a result, the gains of the first and second feedback loops can be separately set, and the gain of the signal F2 can be set to be lower than the gain of the signal F3 as in FIG. 3.

As described above, in the wireless transmission device 6 according to the fourth embodiment, the total of the gain of the filter 14b, the gain of the modulating unit 15, the gain of the coupler 16, and the gain of the demodulating unit 17 is made greater than 0 [dB]. As a result, the gain of the signal F2 can be set to be lower than the gain of the signal F3, so that the distortion of the signal F6 can be suppressed to ensure the stability of the transmission operation.

Further, the frequency characteristics of the first feedback loop are determined by the filter 14a. Further, the frequency characteristics of the second feedback loop are determined by the filter 14a, the filter 14b, the modulating unit 15, the coupler 16, and the demodulating unit 17. Thus, by appropriately designing the filter characteristics of the filter 14a and the filter 14b, the frequency characteristics of the two feedback loops can be arbitrarily set irrespective of the frequency characteristics of the modulating unit 15, the coupler 16, and the demodulating unit 17.

### Fifth Embodiment

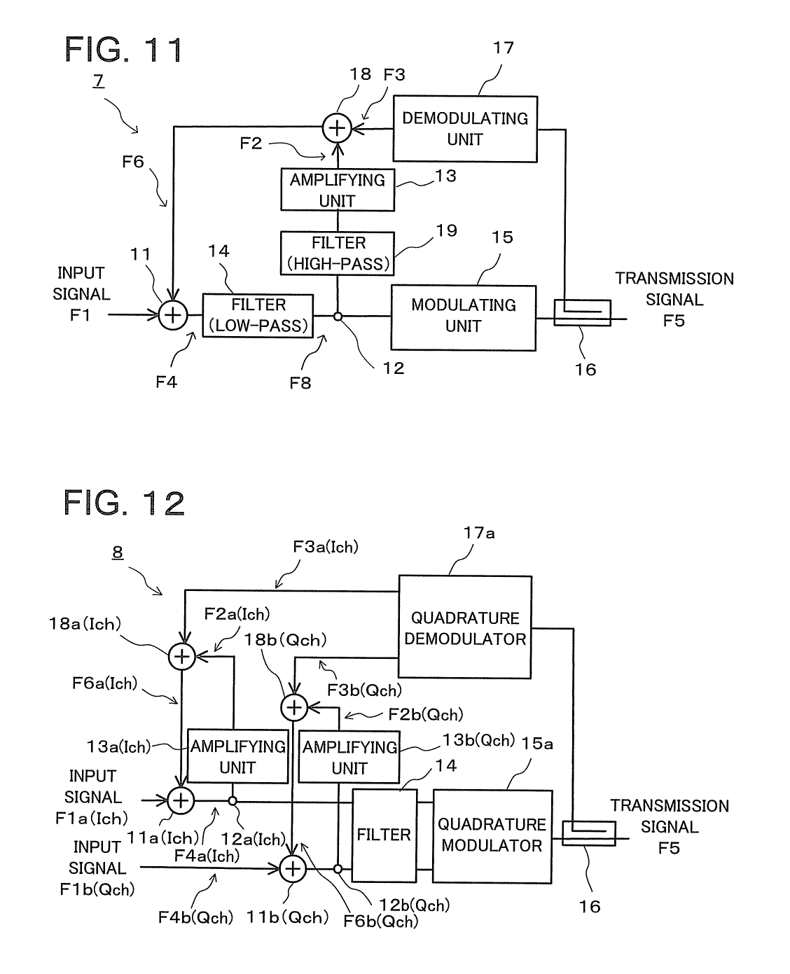

FIG. 11 is a block diagram showing a wireless transmission device 7 according to the fifth embodiment. In the fifth embodiment, a filter 14 having low-pass frequency characteristics is connected to the signal path between the subtractor 11 and the branching device 12. The filter 14 passes the signal F4 generated by the subtractor 11 as a signal F8 (second signal) having preset pass frequency characteristics. The filter 14 functions as a first filter unit passing the second signal generated by the adding/subtracting unit according to preset pass frequency characteristics.

The branching device 12 branches the signal F8 passed through the filter 14.

A filter 19 having high-pass frequency characteristics is connected to the signal path between the branching device 12 and the adder 18. The filter 19 and the amplifying unit 13 pass one of the signals F8 passed through the filter 14 as the signal F2 having preset pass frequency characteristics. The filer 19 functions as a second filter unit passing the second signal passed through the first filter unit according to preset pass frequency characteristics.

The modulating unit 15 modulates the other of the signals F8 passed through the filter 14 to generate the signal F5.

The signal path including the filter 14, the branching device 12, the filter 19, and the amplifying unit 13 constitute the first feedback loop generating the signal F2. Further, the signal path including the filter 14, the branching device 12, the modulating unit 15, the coupler 16, and the demodulating unit 17 constitute the second feedback loop generating the signal F3.

In this fifth embodiment, the filter 19 having high-pass frequency characteristics is included in the first feedback loop, whereby the frequency characteristics of the first feedback loop can be made band-pass frequency characteristics. As a result, the signal F2 is generated as having the same amplitude characteristics and the phase characteristics as those in FIG. 8.

As described above, in the wireless transmission device 7 according to the fifth embodiment, the frequency characteristics of the first feedback loop are made band-pass frequency characteristics, whereby a sufficient phase margin of the signal F2 can be secured and a decrease of the effects of linearization obtained by the signal F3 can be prevented, so that the stability of the transmission operation can be further ensured.

### Sixth Embodiment

FIG. 12 is a block diagram showing a wireless transmission device 8 according to a sixth embodiment. The sixth embodiment is an example in which the wireless transmission device shown in FIG. 1 is applied to a Cartesian feedback loop function having a quadrature modulator 15a for the modulating unit and a quadrature demodulator 17a for the demodulating unit. The signals F1 to F4, and F6 have signals F1a to F4a, and F6a that are I channel signal components and signals F1b to F4b, and F6b that are Q channel signal components, respectively.

A subtractor 11a subtracts the signal F6a from the signal F1a that is the I channel signal component, and a subtractor 11b subtracts the signal F6b from the signal F1b that is the Q channel signal component. An adder 18a adds the signal F2a and the signal F3a that are the I channel signal components, and an adder 18b adds the signal F2b and the signal F3b that are the Q channel signal components.

As the quadrature modulator 15a, two mixers mixing local signals different in phase by 90 degrees and the signal F1a that is the I channel signal component and the signal F1b that is the Q channel signal component which have passed through the filter 14, an adder adding the mixed signals, a driver amplifier, a power amplifier and so on can be used. As in the first embodiment, the power amplifier, or the driver amplifier and the power amplifier may be disposed on the output side (the side of the not-shown antenna) of the coupler 16.

The quadrature demodulator 17a demodulates the signal F5 to generate the signal F3. The quadrature demodulator 17a demodulates the signal F3a that is the I channel signal component and the signal F3b that is the Q channel signal component by branching the signal F5 and mixing the above-described local signals different in phase by 90 degrees and the branched signals F5.

In this sixth embodiment, the signals F2a and F2b do not pass through the second feedback loop generating the signals F3a and F3b as in the first embodiment. Therefore, the signals F2a and F2b are never affected by the time delay due to the second feedback loop, so that their amplitude characteristics and the phase characteristics are the same as those in FIG. 3.

As described above, in the wireless transmission device 8 according to the sixth embodiment, sufficient phase margins of the signals F2a and F2b can be secured even if a time delay of a constant group delay occurs in the first feedback loop generating the signals F2a and F2b in the Cartesian feedback loop having the quadrature modulator 15a and the quadrature demodulator 17a, so that the stability of the transmission operation can be ensured.

Further, also when a phase delay occurs outside the second feedback loop through which the signals F3a and F3b pass to deteriorate the phase margins of the signals F3a and F3b, the phase margins for the signals F6a and F6b generated by addition can be secured by securing sufficient phase margins of the signals F2a and F2b. Especially when the band of the transmission signal is widened and thereby the unity gain frequency is increased, the phase margins for the signals F6a and F6b can be secured by securing sufficient phase margins of the signals F2a and F2b. As a result, the band of the wireless transmission device can be widened. Further, even if the order of the loop filter is increased and thereby the phase margin of the second feedback is decreased, the phase margins for the signals F6a and F6b can be secured by securing a sufficient margin of the signals F2a and F2b. As a result, the order of the loop filter can be increased.

### Seventh Embodiment

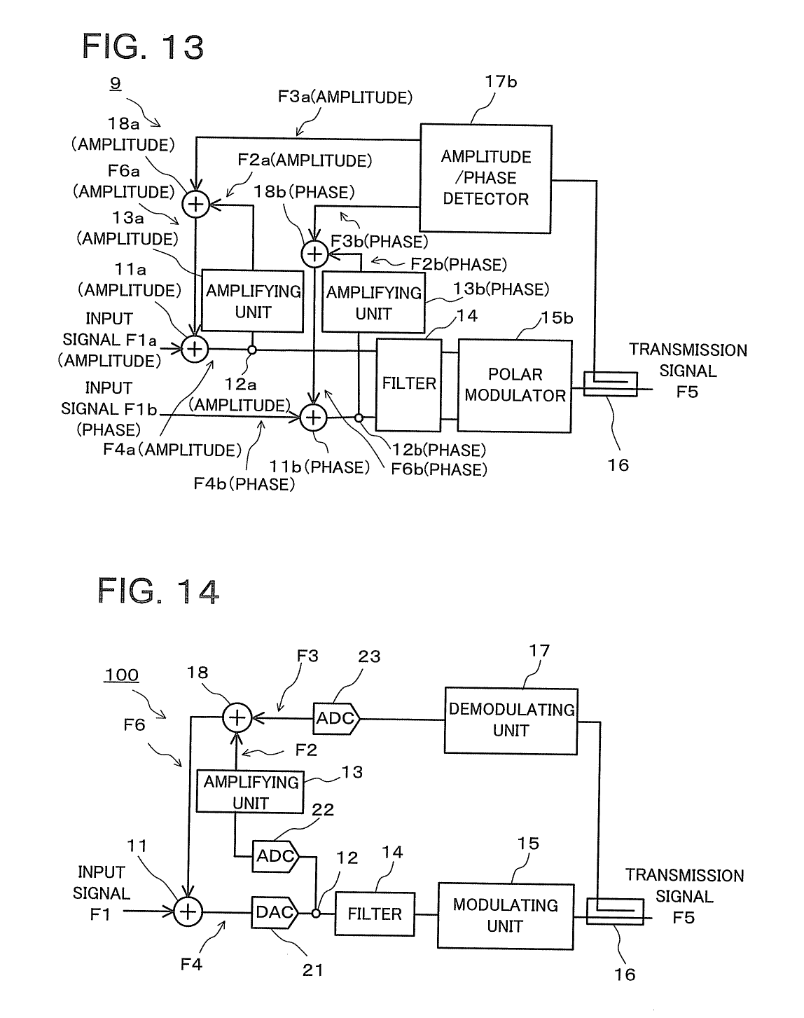

FIG. 13 is a block diagram showing a wireless transmission device 9 according to a seventh embodiment. The seventh embodiment is an example in which the wireless transmission device shown in FIG. 1 is applied to a polar modulating function having a polar modulator 15b for the modulating unit and an amplitude/phase detector 17b for the demodulating unit. The signals F1 to F4, and F6 have signals F1a to F4a, and F6a that are amplitude signal components and signals F1b to F4b, and F6b that are phase signal components, respectively.

A subtractor 11a subtracts the signal F6a from the signal F1a that is the amplitude signal component, and a subtractor 11b subtracts the signal F6b from the signal F1b that is the phase signal component. An adder 18a adds the signal F2a and the signal F3a that are the amplitude signal components, and an adder 18b adds the signal F2b and the signal F3b that are the phase signal components.

As the polar modulator 15b, a voltage controlled oscillator, a power amplifier and so on can be used. The voltage controlled oscillator performs phase modulation by the inputted signal F4 that is the phase signal component. The power amplifier performs amplitude modulation on a signal oscillated by the voltage controlled oscillator by controlling an envelope of the power amplifier by the inputted signal F4 a that is the amplitude signal component. Further, the power amplifier may be replaced with a driver amplifier and disposed on the output side (the side of the not-shown antenna) of the coupler 16.

The amplitude/phase detector 17b demodulates the signal F5 to detect the signal F3a that is the amplitude signal component and the signal F3b that is the phase signal component.

In this seventh embodiment, the signals F2a and F2b do not pass through the second feedback loop generating the signals F3a and F3b as in the first embodiment. Therefore, the signals F2a and F2b are never affected by the time delay due to the second feedback loop, so that their amplitude characteristics and phase characteristics are the same as those in FIG. 3.

As described above, in the wireless transmission device 9 according to the seventh embodiment, sufficient phase margins of the signals F2a and F2b are secured even if a time delay of a constant group delay occurs in the first feedback loop generating the signals F2a and F2b in the polar modulation including the polar modulator 15b and the amplitude/phase detector 17b, so that the stability of the transmission operation can be ensured.

Further, also when a phase delay occurs outside the second feedback loop through which the signals F3a and F3b pass to deteriorate the phase margins of the signals F3a and F3b, the phase margins for the signals F6a and F6b generated by addition can be secured by securing sufficient phase margins of the signals F2a and F2b. Especially when the band of the transmission signal is widened and thereby the unity gain frequency is increased, the phase margins for the signals F6a and F6b can be secured by securing sufficient phase margins of the signals F2a and F2b. As a result, the band of the wireless transmission device can be widened. Further, even if the order of the loop filter is increased and thereby the phase margin of the second feedback is decreased, the phase margins for the signals F6a and F6b can be secured by securing sufficient margins of the signal F2a and F2b. As a result, the order of the loop filter can be increased.

### Eighth Embodiment

FIG. 14 is a block diagram showing a wireless transmission device 100 according to an eighth embodiment. The eighth embodiment is an example in which the wireless transmission device shown in FIG. 1 is applied to a feedback loop function including a digital/analog converter 21. The signals F1 and F6 are composed of digital signals.

The digital/analog converter 21 converts the signal F4 generated by subtraction by the subtractor 11 into an analog signal. An analog/digital converter 22 converts the signal F2 generated by the branching device 12 into a digital signal. An analog/digital converter 23 converts the signal F3 demodulated by the demodulator 17 into a digital signal.

In the eighth embodiment, the signal F2 does not pass through the second feedback loop generating the signal F3 as in the first embodiment. Therefore, the signal F2 is never affected by the time delay due to the second feedback loop, so that its amplitude characteristics and phase characteristics are the same as those in FIG. 3.

As described above, in the wireless transmission device 100 according to the eighth embodiment, a sufficient phase margin of the signal F2 is secured even if a time delay of a constant group delay occurs in the first feedback loop generating the signal F2 in the feedback loop including the digital/analog converter 21, so that the stability of the transmission operation can be ensured.

Further, also when a phase delay occurs outside the second feedback loop through which the signal F3 passes to deteriorate the phase margin of the signal F3, the phase margin for the signal F6 generated by addition can be secured by securing a sufficient phase margin of the signal F2. Especially when the band of the transmission signal is widened and thereby the unity gain frequency is increased, the phase margin for the signal F6 can be secured by securing a sufficient phase margin of the signal F2. As a result, the band of the wireless transmission device can be widened. Further, even if the order of the loop filter is increased and thereby the phase margin of the second feedback is decreased, the phase margin for the signal F6 can be secured by securing a sufficient margin of the signal F2. As a result, the order of the loop filter can be increased.

### Modification Example 1

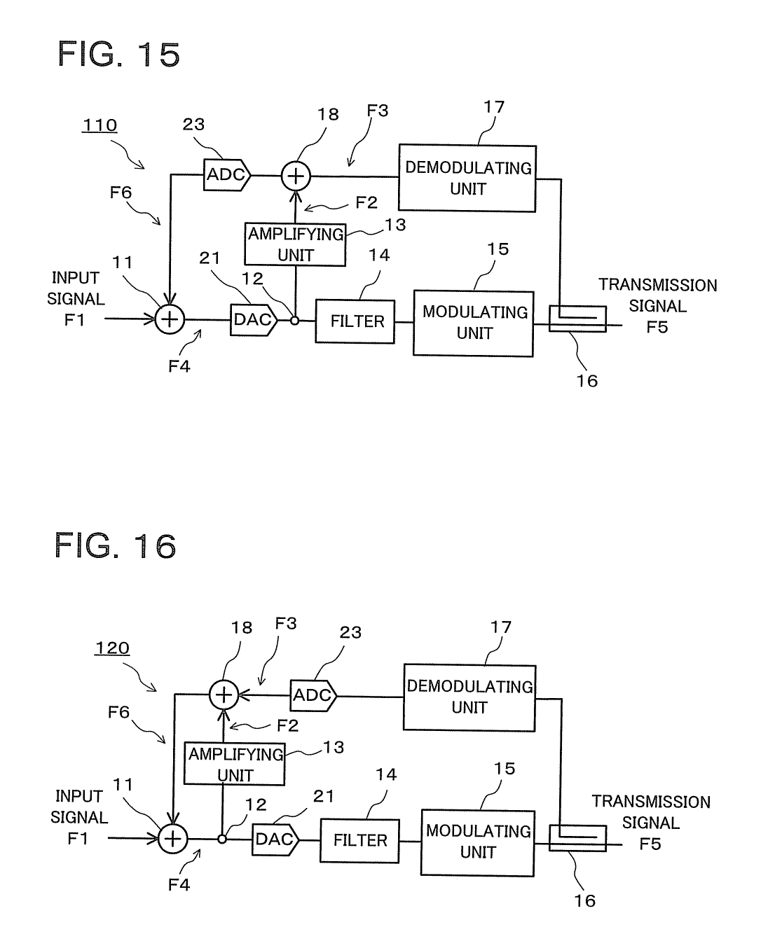

FIG. 15 is a block diagram showing a wireless transmission device 110 according to a modification example 1 of the eighth embodiment. In this modification example 1, the analog/digital converter 23 is connected to the signal path between the adder 18 and the subtractor 11 to convert the signal F6 generated by the adder 18 into a digital signal.

In the wireless transmission device 110 according to the modification example 1, the analog/digital converter 23 is connected to the signal path between the adder 18 and the subtractor 11. As a result, the analog/digital converter can be implemented by one unit to reduce the manufacturing cost.

### Modification Example 2

FIG. 16 is a block diagram showing a wireless transmission device 120 according to a modification example 2 of the eighth embodiment. In this modification example 2, the first feedback loop constituted by the signal path including the branching device 12 and the amplifying unit 13 is the signal path for a digital signal. The second feedback loop constituted by the signal path including the filter 14, the modulating unit 15, the coupler 16, and the demodulating unit 17 is the signal path for an analog signal.

In this case, the digital/analog converter 21 is connected to the signal path between the branching device 12 and the filter 14. The analog/digital converter 23 is connected to the signal path between the demodulating unit 17 and the adder 18.

As described above, in the wireless transmission device 120 according to the modification example 2 of the eighth embodiment, when the conventional second feedback loop generating the signal F3 is connected to the first feedback loop generating the signal F2 according to the present invention, they can be easily connected even if the signal forms are different, because converter converting the signal form are disposed between the loops. Also when the first feedback loop is the signal path for an analog signal and the second feedback loop is the signal path for a digital signal, they can be easily connected as in the above case.

Further, also when the first feedback loop and the second feedback loop are configured in separate units, both the loops can be easily connected. Further, in this case, when failure occurs in any one of the units, the loop can be replaced with another, unit by unit, whereby complication at replacement can be reduced.

Embodiments of the present invention are not limited to above-described embodiments, but can be expanded and modified, and the expanded and modified embodiments are also included in the technical scope of the present invention.

What is claimed is:

1. A wireless transmission device, comprising:
an adding/subtracting unit configured to subtract a second signal and a third signal from a first signal to generate the second signal;
a modulating unit configured to modulate the second signal generated by the adding/subtracting unit to generate a fourth signal;
a demodulating unit configured to demodulate the fourth signal to generate the third signal; and
a transmitting unit configured to transmit the fourth signal.

2. The device according to claim 1,
wherein the adding/subtracting unit comprises:
an adder configured to add the second signal and the third signal to generate a fifth signal; and
a subtractor configured to subtract the fifth signal generated by the adder from the first signal to generate the second signal.

3. The device according to claim 1, further comprising,
an amplifying unit configured to amplify the second signal,
wherein the modulating unit modulates the second signal generated by the adding/subtracting unit to generate the fifth signal; and
wherein the adding/subtracting unit subtracts the second signal amplified by the amplifying unit and the third signal generated by the demodulating unit from the first signal to generate the second signal.

4. The device according to claim 3,
wherein a frequency when a gain of the amplifying unit is 0 [dB] has a value higher than a value of a frequency when a total gain of the modulating unit and the demodulating unit is 0 [dB].

5. The device according to claim 1, further comprising,
an amplifying unit configured to amplify the second signal,
wherein the modulating unit modulates the second signal amplified by the amplifying unit to generate the fourth signal; and
wherein the adding/subtracting unit subtracts the second signal amplified by the amplifying unit and the third signal generated by the demodulating unit from the first signal to generate the second signal.

6. The device according to claim 5,
wherein a frequency when a gain of the amplifying unit is 0 [dB] has a value higher than a value of a frequency when a total gain of the gain of the amplifying unit, a gain of the modulating unit, and a gain of the demodulating unit is 0 [dB].

7. The device according to claim 1, further comprising,
a filer unit configured to pass the second signal according to preset pass frequency characteristics,
wherein the modulating unit modulates the second signal generated by the adding/subtracting unit to generate the fourth signal; and
wherein the adding/subtracting unit subtracts the second signal passed through the filter unit and the third signal generated by the demodulating unit from the first signal to generate the second signal.

8. The device according to claim 7,
wherein the filter unit has any of low-pass frequency characteristics, high-pass frequency characteristics, and band-pass frequency characteristics.

9. The device according to claim 7,
wherein the pass frequency characteristics of the filter unit are set such that a frequency when a gain of the filter unit is 0 [dB] has a value higher than a value of a frequency when a total gain of a gain of the modulating unit and a gain of the demodulating unit is 0 [dB].

10. The device according to claim 1, further comprising,
a filter unit configured to pass the second signal according to preset pass frequency characteristics,
wherein the modulating unit modulates the second signal passed through the filter unit to generate the fourth signal; and
wherein the adding/subtracting unit subtracts the second signal passed through the filter unit and the third signal generated by the demodulating unit from the first signal to generate the second signal.

11. The device according to claim 10,
wherein a total of gains of the modulating unit and the demodulating unit is greater than 0 [dB].

12. The device according to claim 7,
wherein the filter unit has a gain of 0 [dB] or greater.

13. The device according to claim 1, further comprising:
a first filter unit configured to pass the second signal generated by the adding/subtracting unit according to preset pass frequency characteristics; and
a second filter unit configured to pass the second signal passed through the first filter unit according to preset pass frequency characteristics,
wherein a total of gains of the second filter unit, the modulating unit, and the demodulating unit is greater than 0 [dB];
wherein the adding/subtracting unit subtracts the second signal passed through the first filter unit and the third signal generated by the demodulating unit from the first signal to generate the second signal; and
wherein the modulating unit modulates the second signal passed through the second filter unit to generate the fourth signal.

14. The device according to claim 1, further comprising:
a first filter unit configured to pass the second signal generated by the adding/subtracting unit according to preset pass frequency characteristics; and
a second filter unit configured to pass the second signal passed through the first filter unit according to preset pass frequency characteristics,
wherein the modulating unit modulates the second signal passed through the first filter unit to generate the fourth signal.

15. The device according to claim 14,
wherein the first filter unit passes the second signal generated by the adding/subtracting unit according to preset low-pass frequency characteristics; and
wherein the second filter unit passes the second signal passed through the first filter unit according to preset high-pass frequency characteristics.

16. The device according to claim 1,
wherein the first to third signals have I channel signal components and Q channel signal components;
wherein the modulating unit includes a quadrature modulator configured to modulate the second signal having the I channel signal component and the Q channel signal component respectively generated by addition/subtraction by the adding/subtracting unit to generate the fourth signal; and
wherein the demodulating unit includes a quadrature demodulator configured to demodulate the fourth signal generated by the modulating unit to generate the third signal having the I channel signal component and the Q channel signal component.

17. The device according to claim 1,
wherein the first to third signals have amplitude signal components and phase signal components;
wherein the modulating unit includes a polar modulator configured to modulate the second signal having the amplitude signal component and the phase signal component respectively generated by addition/subtraction by the adding/subtracting unit to generate the fourth signal; and
wherein the demodulating unit includes an amplitude/phase detector configured to detect the third signal having the amplitude signal component and the phase signal component from the fourth signal generated by the modulating unit.

18. The device according to claim 1, further comprising:
a first converting unit configured to convert the third signal demodulated by the demodulating unit into a digital signal; and
a second modulating unit configured to convert the second signal generated by addition/subtraction by the adding/subtracting unit into an analog signal,
wherein the first signal has a digital signal.

19. A wireless transmission method, comprising:
an adding/subtracting unit subtracting a second signal and a third signal from a first signal to generate the second signal;
a modulating unit modulating the second signal generated by the adding/subtracting unit to generate a fourth signal;
a demodulating unit demodulating the fourth signal to generate the third signal; and
a transmitting unit transmitting the fourth signal.
